(19) United States
(12) Patent Application Publication
(10) Pub. No.: US 2025/0288146 A1
(43) Pub. Date: Sep. 18, 2025

(54) BEVERAGE POD SYSTEM WITH POD RECOGNITION

(71) Applicant: SOCIETE DES PRODUITS NESTLE S.A., Vevey (CH)

(72) Inventors: ARMIN GEMPERLE, Wil SG (CH); LARRY LUKAS BURGE, Fischingen (CH); SILVIA QUATTRONE, Lausanne (CH); ARAMIA ASMAR, Yverdone-les-bains (CH); FREDERIC FRAGNIERE, Orbe (CH)

(21) Appl. No.: 18/855,009

(22) PCT Filed: Apr. 6, 2023
(86) PCT No.: PCT/EP2023/059121

§ 371 Date: Oct. 8, 2024

(30) Foreign Application Priority Data
Apr. 8, 2022 (EP) 22167448.4

(51) Int. Cl. A47J 31/44; A47J 31/36

(52) U.S. Cl. CPC A47J 31/4492; A47J 31/3628; A47J 31/3633

(57) ABSTRACT

The invention concerns an extraction device for extracting a beverage ingredient from a pod, said pod (3) comprising a code (34), said device comprising: —upstream and downstream pod enclosing parts (1, 2) relatively movable between an open position for inserting and removing the pod (3) and a closed position and a code reader (71), —a removable pod holder (6), —a top insertion section (4) for introducing the pod holder (6) in the device, —a pod holder stopper (42) to stop the pod holder (6) in an intermediate temporary position inside said path (41), and wherein, in the intermediate temporary position, the pod holder (6) is configured to hold the pod so that the code (34) arranged on the pod faces the code reader (71), and wherein the operation of reading the code by the code reader is triggered by the movement of the pod holder (6) when the pod holder reaches the intermediate temporary position during the introduction of the pod holder in the device.

### FIELD OF THE INVENTION

The present invention relates to the field of preparation of beverages with a system including a single-serve container comprising a beverage ingredient and a machine that has an extraction chamber in which the container can be inserted, extracted and from which it can be removed.

### BACKGROUND OF THE INVENTION

Single serve containers for the automatic preparation of beverages encompass various formats of containers that can be extracted according to different types of systems. In these systems, the container introduced by the user inside the system becomes enclosed in a chamber to perform the extraction process and then is removed from the chamber. The chamber comprises two parts configured to be moved apart during the introduction of the container and then moved one to the other to form the extraction chamber around the container for the beverage extraction.

The container can be introduced in these systems according to different manners.

In one particular type of system, the user introduces the container inside a receiving area of the system that leads the container directly between the two parts of the machine like in EP 1859714 or EP1646305. In such a type of system, the two parts of the chamber are generally movable one to the other along a horizontal direction and the container can be introduced inside the two parts and then removed from the chamber along the perpendicular vertical direction to take benefit of the gravity fall of the container in these operations.

Accordingly, such a type of system requires the provision of container catchers and container ejectors inside the chamber to control the movement of the container which makes manufacturing more complex.

In some systems, the container presents an identification or recognition means or code that is read by a code reader of the system before the beverage is prepared. This identification or recognition means or code provides the system with information about the container like the beverage ingredient stored in the container or the size of the container. Such information can be used to adapt the beverage preparation to the container to implement the best preparation.

Different types of identification or recognition means or code exist and are adapted to different types of reader like optical, mechanical, magnetic, . . .

In the systems such as described above, where the container is introduced in the two parts of the brewing chamber by gravity fall, the reading operation requires that the container is stopped in its fall to operate the reading. Usually, this stop can be obtained by closing the path of the container with a stopper, that is driven by a motor.

Some of these readers require that during the reading operation, the reader and the identification or recognition means or code are placed very close one to the other and that even a part of the reader contacts the part of the container that holds the identification or recognition means or code. Such a reading operation requires that the container is stopped very close to the code reader and the code reader and/or the container are/is moved one to the other. This operation can increase the time of preparation of the beverage, which is not convenient for the user. In addition, this operation is often implemented by means of a motor to control the relative movement of the container and the code reader, which increases the cost of production of the system again.

An object of the invention is to address at least the above existing drawbacks.

### SUMMARY OF THE INVENTION

In a first aspect of the invention, there is provided an extraction device for extracting a beverage ingredient by supplying an extraction liquid into a pod,

said pod comprising:
a pod body, said pod body comprising:
   a side wall and a bottom wall defining a chamber, said chamber extending axially between the bottom and a top opening, and
a top lid closing the top opening of the pod body,
a machine-readable code storing preparation information, said code being arranged on the pod, and
said device comprising upstream and downstream pod enclosing parts relatively movable, preferably translatable, along a horizontal longitudinal axis (XX′) between an open position for inserting and removing the pod and a closed position for forming an extraction chamber enclosing the pod during extraction,
said device comprising a code reader,
wherein the device comprises:
a removable pod holder, said holder comprising a pod receiving hole to receive and hold the pod,
a top insertion section configured for introducing the pod holder in the device, said top insertion section comprising a path for guiding the pod holder to an extraction area between the upstream and downstream pod enclosing parts, and
a pod holder stopper to stop the pod holder in an intermediate temporary position inside said path, and
wherein, in the intermediate temporary position, the pod holder is configured to hold the pod so that the code arranged on the pod faces the code reader, and
wherein the operation of reading the code by the code reader is triggered by the movement of the pod holder when the pod holder reaches the intermediate temporary position during the introduction of the pod holder in the device.

Accordingly, the relative movement of the code reader with the code of the pod is actuated by the user who introduces the pod holder inside the extraction device manually.

Preferably, the pod holder is fully removable, meaning detachable from the extraction device, in particular the pod holder can be fully removed out of the top insertion section. Then, it can be put back in the extraction device. Accordingly, the user can easily introduce the pod inside the holder when the pod holder is outside the extraction device; the user can easily carry the pod holder positioned within the holder to the bin after extraction and then position the pod holder back in the extraction device with or without a new pod.

Preferably, the pod receiving hole and the top insertion section are configured to orientate the code in front of the code reader when the pod holder is in the intermediate position.

In one preferred embodiment, orientation means are configured to orientate the part of the pod that presents the code inside the holder and inside the path so that said code faces the code reader when the pod holder is in the intermediate temporary position.

Such orientation means can be a specific design of the holder and of the insertion path of the extraction device respectively in order to urge the user to position the pod and the pod holder in one manner only.

These mean can also enable the right orientation of the pod in view of the downstream or upstream enclosing parts depending on the construction of the pod.

Generally, the holder and its hole are designed so that once the pod is positioned in the hole, at least a part of the lid and at least a part of the bottom of the pod is not covered or enclosed by the pod holder and remains accessible for being contacted by the code reader when the pod holder is in the intermediate temporary position.

In addition, usually, at least a part of the lid and at least a part of the bottom of the pod is not covered or enclosed by the pod holder to remain accessible for the downstream and upstream pod enclosing parts during the beverage preparation, preferably accessible to piercing elements of said enclosing parts.

Preferably, the whole surfaces of the lid and the pod body bottom are uncovered by the holder.

Accordingly, these parts remain fully accessible by the code reader and the piecing elements of the extraction device.

The holder stopper provides a means to prevent the user, who is introducing the holder manually inside the insertion path, from pushing the pod holder beyond the intermediate temporary position inside said path. When the pod holder is stopped in this intermediate temporary position, the pod hold in the pod holder is well positioned to be read by the code reader.

This intermediate position of the holder enables recognition step by the code reader, in order to:
provide the process control unit of the extraction device with information related to the beverage preparation (authorised pod, optimal recipe), or
stop the preparation if a defect is identified (already extracted pod that was not removed from the holder) and alert the user through a display. The user can immediately remove the holder and check the pod in the holder.

In the intermediate temporary position, the pod holder is inserted partially only inside the extraction device, in particular the upper part of the holder remains accessible by the user who is able to withdraw the holder from this position.

This intermediate temporary position can be configured to enable the user to load the device with the pod holder before the holder is further displaced automatically to the brewing chamber formed by the upstream and downstream enclosing parts.

According to the invention, the operation of reading the code by the code reader is triggered by the movement of the pod holder. When the pod holder reaches the intermediate temporary position the reading of the code is automatically simultaneously actuated.

The triggering action of the pod holder on the movement of the reader coordinates the movements of the reader and of the pod holder to avoid the use of a motor and to make the recognition step fast.

In the preferred embodiment, the code reader is movable between:
a retracted position, where the code reader is positioned out of the path of the insertion section, and
a reading position, where the code reader extends inside the path of the insertion section, and
the movement of the code reader from the retracted position to the reading position is triggered by the pod holder when the pod holder reaches the intermediate temporary position during the introduction of the pod holder in the device.

According to this embodiment, the code reader is movable between two positions. The first position is a default retracted position where the code reader is positioned aside the insertion section and does not prevent the pod holder from sliding in the insertion path. The second position is a reading position, where the code reader extends partially inside the path of the insertion section and contacts the surface of a pod hold in the holder.

The second position of the reader guarantees a good reading of the code that is provided on the surface of the pod.

The first position of the reader enables the free movement of the pod and the pod holder to the intermediate temporary position. Generally, this movement is vertical.

The intermediate temporary position of the pod holder enables the correct reading by the code reader in its second position.

The triggering action of the pod holder on the movement of the reader coordinates the movements of the reader and of the pod holder to avoid the use of a motor and to make the recognition step fast.

Usually, the movement of the code reader is perpendicular to the movement of the pod holder.

Generally, the movement of the pod holder is vertical whereas the movement of the reader is horizontal.

Preferably, the movement of the code reader from the reading position back to the retracted position is triggered by the pod holder when the pod holder moves from the intermediate temporary position to the extraction area.

Consequently, the code reader is positioned back at the first default position during the further movement of the pod holder and during the beverage preparation. With this default position, the risk of damaging a part of the code reader during the beverage preparation is limited.

In one preferred embodiment, the code reader is supported by a movable frame, and during the movement of the pod holder inside the path of the insertion device, the frame of the code reader can be successively:
spring tensioned while retained in the retracted position by a retaining means,
then moved to the reading position by removing the retaining means, and
then set back to the retracted position by releasing the tension of the spring.

In this embodiment, preferably:
the frame of the code reader is spring tensioned by a lever that is actuated by the pod holder, and
the retaining means is moved by the pod holder too.

Preferably, the extraction device comprises an actuator to move the pod holder from the intermediate position to the extraction area between the upstream and downstream pod enclosing parts.

This actuating means is preferably manually actuated, like a handle. As a result, the machine can be manually operated directly, when loading the pod with the pod holder to the intermediate temporary position, and indirectly with the handle moving the pod holder to the extraction area.

Preferably, this actuator can be cinematically linked to the holder stopper so that said stopper is configured to move the pod holder from the intermediate position to the extraction area when said actuator is operated.

As a result, even if the actuator is operated manually, the holder is automatically moved to the extraction area which guarantees a correct positioning inside the two enclosing parts. This is preferable when the two enclosing parts are both movable one to the other as mentioned below.

Preferably, the pod holder and the holder stopper are designed so that the stopper is able to engage a surface of the pod holder and drive the holder during the movement of the stopper by the actuator.

In one preferred embodiment, the actuator comprises a handle, and this handle closes the path of the top insertion section when the downstream and upstream parts are in the closed position.

Consequently, the movement of the handle simultaneously positions the holder between the pod enclosing parts and closes the path to prevent the operator to pull the holder while an extraction operation is happening.

According to one preferred embodiment:
the upstream enclosing part defines a cage and bears an upstream piercing arrangement for opening the bottom wall of the pod and a liquid injector,
the downstream part defines a plate transverse to the longitudinal axis (XX′), said plate comprising a downstream plane piercing arrangement for opening the lid of the pod, and
each of the downstream and upstream parts are movable between a respective open position for inserting and removing the pod holder and a respective closed position for forming an extraction chamber that encloses the pod holder during extraction.

The movements of each of the upstream and enclosing parts to and away from the pod are preferred because frequently, further to the beverage extraction, a part of the lid or of the bottom of the pod body can remain engaged with the piercing elements rising from said parts.

The movements of these enclosing parts enable the disengagement from the pod and a safe removal of the pod holder.

The actuating means can be configured to coordinate the movement of the upstream and downstream parts and the movement of the pod holder so that:
the pod holder is positioned in the extraction area between the two enclosing parts before these parts enclose the pod, and
the two enclosing parts are moved away from the pod before the pod holder is removed from the extraction area.

Preferably, the relative movement of the upstream and downstream enclosing parts is linear.

It is preferably a translation. Preferably, the introduction and removal of the pod holder is linear too and preferably perpendicular to the linear movement of the enclosing parts.

As a result, the dimension of the extraction device can be kept small.

Preferably, the pod holder comprises orientation means to orientate the pod correctly inside the holder and then inside the extraction device, in particular in view of the downstream or upstream parts depending on the construction of the pod.

In one preferred embodiment, orientation means are configured to orientate the lid of the pod so at that it faces either the downstream or upstream part, depending on the construction of the pod.

Such orientation means can be a specific design of the holder and of the insertion path of the extraction device urging the user to position the pod and the pod holder in one manner only.

In a second aspect of the invention, there is provided a beverage preparation machine comprising an extraction device such as described above.

Generally, this beverage machine comprises a liquid supply system connected to the upstream enclosing part. This liquid supply system can comprise:
a liquid supply such as a liquid tank,
pumping means to drive liquid form the liquid supply to the extraction device,
heating and/or cooling means to adapt the temperature of the liquid before it is introduced inside the pod.

The liquid is usually water.

Usually, this beverage machine comprises a control unit configured to control at least the supply of liquid to the extraction device. The control unit can be configured to control the recognition operation of the recognition device if present or to display information to the user.

In a third aspect of the invention, there is provided a system comprising an extraction device such as described above and a pod or comprising a beverage preparation machine such as described above and a pod,
wherein this pod comprises:
a pod body, said pod body comprising a side wall and a bottom wall defining a chamber, and
a top lid closing the top opening of the pod body, and
a machine-readable code storing preparation information, said code being arranged on the pod, preferably on the lid of the pod, and
wherein the pod holder and the insertion section are designed so that the lid faces the code reader in the path of the insertion section.

In a fourth aspect, there is provided a method to prepare a beverage with a device such as described above, comprising the steps of:
removing the pod holder,
introducing a pod in the pod holder,
introducing the pod holder in the extraction device down to the temporary position,
actuating the actuating means to move the pod holder from the intermediate position to the extraction area

In a fifth aspect, there is provided the use of pod holder in the extraction device or in the beverage machine such as described, wherein:
this pod holder comprises a pod receiving hole to receive and hold the pod, and
said pod holder is designed to trigger the operation of code reading during the introduction of the pod holder in the extraction device.

In the present application:
the term “pod” is used to broadly designate any kind of single-dose container suitable for preparing beverages or other edible products such as capsules, cartridges, portioned or individual packages without limitation to the shape of this container, the material this container is made of or the types of piercing means needed to extract the beverage therefrom.
the term “longitudinally” refers to the orientation of the two enclosing parts one to the other and their movement along the longitudinal axis XX′.
the term “vertically”, “upwardly” and “downwardly” refers to the movement of the pod in the extraction device from its introduction between the two enclosing parts and its removal therefrom. The terms “upper” and “lower” refer to this vertical axis too.
the terms “upstream” and “downstream” refer to the path of liquid through the extraction device from the upstream enclosing part to the downstream enclosing part.

Generally, these terms are used to describe the relational positioning of features of the extraction device. These terms should be understood to refer to said device in its normal orientation when positioned in a beverage machine for the production of a beverage as shown in the FIGS. 2A, 2E, and 4A to 4H.

The above aspects of the invention may be combined in any suitable combination. Moreover, various features herein may be combined with one or more of the above aspects to provide combinations other than those specifically illustrated and described. Further objects and advantageous features of the invention will be apparent from the claims, from the detailed description, and annexed drawings.

### BRIEF DESCRIPTION OF THE DRAWINGS

Specific embodiments of the invention are now described further, by way of example, with reference to the following drawings in which:

FIGS. 1A to 1C are different perspective view of pods used in the extraction device of the present invention,

FIG. 2A and 2D are side and top views respectively of an extraction device according to the invention the pod holder being removed therefrom,

FIGS. 2B and 2C are perspective views of some isolated parts of said extraction device of FIG. 2A,

FIGS. 2E is a side view of the extraction device of FIG. 2A with the pod holder enclosed inside and FIG. 2F is side view of some isolated parts of said extraction device of FIG. 2E,

FIG. 3A is a front view of the holder holding a pod,

FIG. 3B is a back view of the holder holding a pod,

FIGS. 3C is perspective view of the holder without any pod,

FIG. 3D is a bottom view of the holder holding a pod,

FIGS. 4A-4H are cross section views illustrating the steps of introduction of the pod holder inside the extraction device according to the preferred embodiment,

FIGS. 4I-4K are cross section views illustrating the steps of removal of the pod holder from the extraction device according to the preferred embodiment,

FIG. 5 is a magnified view of a part of FIG. 4H,

FIG. 6 illustrates the fluid system of the extraction device.

FIG. 7A is an isolated perspective view of the movable code reader assembly of the extraction device and FIG. 7B a side view of said assembly,

FIG. 7C is a magnified view of the insertion section of FIG. 2D and FIG. 7D is the vertical section view along plane AA in FIG. 7C,

FIGS. 7E-7F are side view of the extraction device showing the relative engagement of the code reader assembly and the pod holder in the different operative positions.

### DETAILED DESCRIPTION OF EXEMPLARY EMBODIMENTS

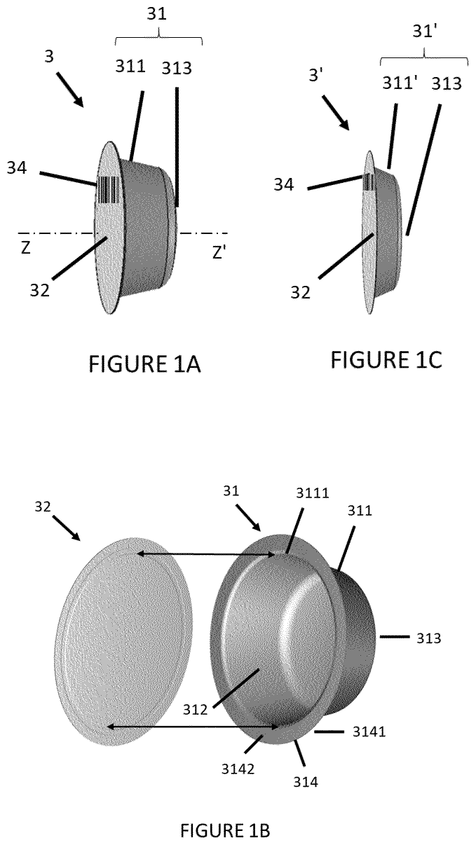

FIGS. 1A (perspective view) and 1B (exploded view) illustrate a pod 3 that can be used in the extraction device of the invention.

The pod 3 comprises a pod body 31 with one sidewall 311 that extends axially from a bottom wall 313 towards a top. The sidewall 311 extends towards a top opening 312. At the top opening 312, the body comprises a circumferential annular flange 314 that extends radially outward from the sidewall 311 along the circumference of the opening 312.

The flange comprises an upper surface 3142 facing the top and a lower surface 3141.

Generally, any transversal cross section of the body is circular from the bottom to the top and the flange is circular too.

The body delimits a chamber for containing a beverage ingredient.

This beverage ingredient is preferably an ingredient able to be extracted like roast and ground coffee.

In a less preferred manner, the beverage ingredient can be tea leaves or a water soluble powder ingredient such as: instant coffee powder, milk powder, cream powder, instant tea powder, cocoa powder, soup powder, fruit powder or mixture of said powders or even a soluble liquid ingredient or a beverage concentrate such as a syrup or milk concentrate. The powders can be agglomerated or sintered.

The capsule comprises a lid 32 that is fixed, sealed or attached to at least a part of the upper surface 3142 of the circumferential flange and accordingly covers and closes the top opening 312.

A machine-readable code 34 is arranged on the lid. This code can provide different types of information such as:
the nature of the beverage ingredient,
the size of the pod,
authorised pod,
the extraction recipe to applied to the pod: temperature of the fluid, volume of the fluid, flow of the fluid, . . .

The bottom wall 313 is adapted to be pierced so that liquid can be injected in the pod through the pierced openings.

The lid 32 is adapted to be opened by relative engagement with a piercing arrangement under the effect of the liquid pressure increase inside the pod during injection of liquid.

The pod shape is symmetric relatively to the central axial axis ZZ′ extending from the bottom wall to the lid and the pod shape is asymmetrical relatively to the plane of the lid and the flange.

FIG. 1C illustrates another pod 3′ that can be used in the extraction device of the invention and differ from the pod 3 of FIG. 1A only by the depth size (along axis ZZ′) of the pod bodies 31′. The pod body 31 of the big pod 3 defines an ingredient chamber with a bigger volume than the pod body 31′ of the small pod 3′, the side wall 311 being higher than the side wall 311′. The diameter of the lids 32, 32′ of the small and big pods are identical.

This difference in sizes enable the preparation of different beverages, preferably different coffee beverages like ristretto, espresso, lungo (long cups), americano, . . .

Other sizes than those illustrated can be provided, like an intermediate size.

The machine-readable code 34 can store information about the size of the pod.

The extraction device of the present invention can be configured for using alternative containers to those described above as soon as they comprise a body defining a chamber and a lid to close the chamber. The two enclosing parts just needs to present internal shapes conformal to the containers.

For example, the container can be a frusto-conical capsule made of aluminum or plastic.

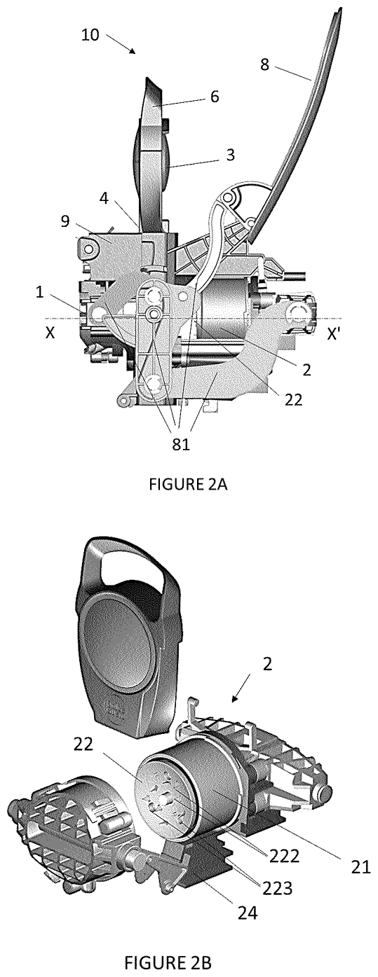

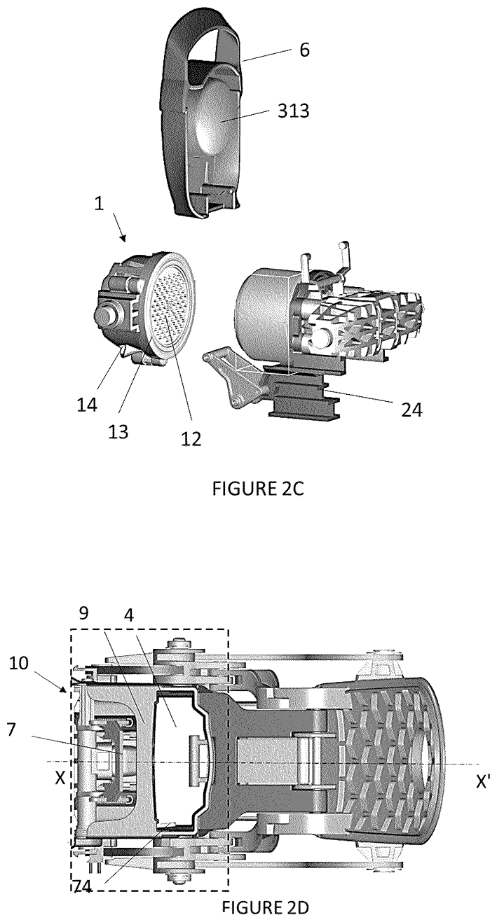

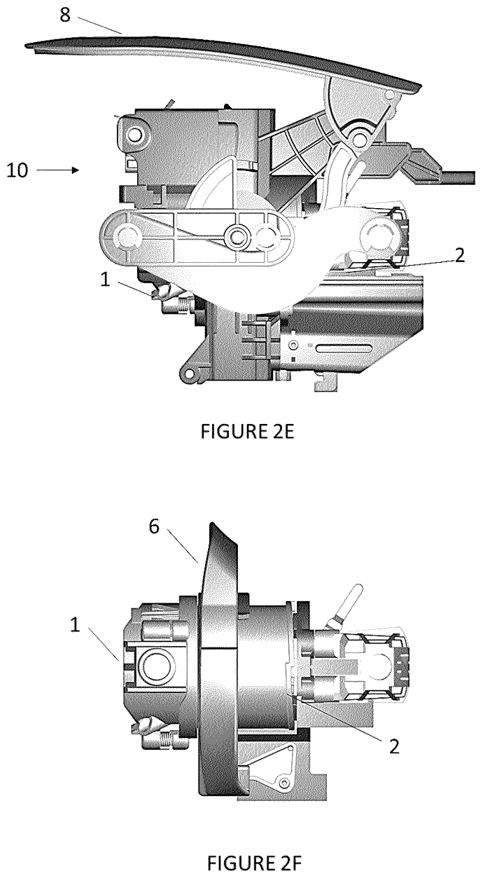

FIG. 2A is a side view of an extraction device 10 according to the invention comprising an upstream pod enclosing part 2 and a downstream pod enclosing part 1 relatively translatable along a longitudinal axis XX′. Usually, this axis XX′ is essentially horizontal. In FIG. 2A, these two parts are in an opened position configured to receive a pod for extraction. These two enclosing parts are supported by a chassis 9 and made movable from said opened position to a closed position by actuating a handle 8 connected to these enclosing parts by a system 81 of interrelated knee levers.

The device comprises a pod holder 6 that holds a pod 3. This holder is fully removable from the extraction device and is illustrated in FIG. 2A outside the chassis where it is ready for an operation of introduction between the enclosing parts or at the end of said operation during the removal of the extracted pod form the extraction device. The pod is introduced through an insertion section 4 positioned above the two enclosing parts 1, 2.

FIGS. 2B and 2C are perspective and isolated view of the two pod enclosing parts 1, 2 and the pod holder 6 in the position illustrated in FIG. 2A.

The downstream part 1 comprises a plate perpendicular (that is transverse) to the longitudinal axis XX′. This plate comprises a central downstream plane piercing arrangement 12 for opening the lid 32 of the pod when the extracting liquid is introduced inside the pod and inflates the lid.

Usually, this central downstream plane piercing arrangement 12 is circular like the lid of the pod.

Opening happens by relative engagement of spikes with the lid under the effect of the rise in pressure of the injected liquid in the pod body chamber. This downstream plane piercing arrangement may comprise a rigid plate comprising opening elements 121 such as spikes, that can present the shape of cones or pyramids, optionally truncated at their ends, on its surface turned to the lid. In addition, the plate comprises traversing holes to evacuate the beverage dispensed from the opened lid to a beverage outlet 14, such as a tube or nozzle collecting and dispensing beverage to a drinking cup.

The plate comprises a peripheral area 13 surrounding that piercing arrangement 12.

The upstream part 2 defines a cage 21 or cavity for enclosing the pod body. This cage presents an adjustable internal volume. A movable end wall 22 transverse to the longitudinal axis XX′ of the cage enables this adjustment. This end wall 22 bears piercing elements 222 for opening the bottom wall 313 of the pod body and liquid outlet openings 223 for supplying liquid into the pod through the holes opened in the bottom wall of the pod. These piercing elements can comprise piercers in the form of blades. These blades can be designed and positioned to pierce the wall of the bottom of the pod body when the upstream and downstream pod enclosing parts are brought to the closed position. The liquid outlet openings 223 can form a shower at the upstream wall of the cage and the supplied liquid can be introduced in the pod through the pre-pierced openings.

Since pods 2 of different sizes can be introduced and extracted, the end wall 22 of the cage can be made movable to adapt the cage internal volume to the pod.

The upstream part 2 is supported by a carrier 24 that enables its movement along the axis XX′.

The top view of the extraction device in FIG. 2D shows the insertion section 4 for the pod holder that is provided in the chassis 9. This insertion section 4 is designed to enable the introduction of the pod holder 6 so that the lid 32 of the pod hold in the holder is positioned in front the of the downstream enclosing part 1.

This view makes apparent that the extraction device comprises a code reader 7 positioned aside the insertion section and above the two enclosing parts 1, 2 and configured to read a code on a capsule positioned in the insertion section.

FIGS. 2E and 2F illustrate the extraction device of FIGS. 2A-2C wherein the pod holder 6 is positioned between the upstream pod enclosing part 2 and the downstream pod enclosing part 1 and these two parts have been moved one to the other by actuation of the interrelated levers by the handle 8. In this position, the pod holder 6 is firmly pinched between the two enclosing parts 1,2.

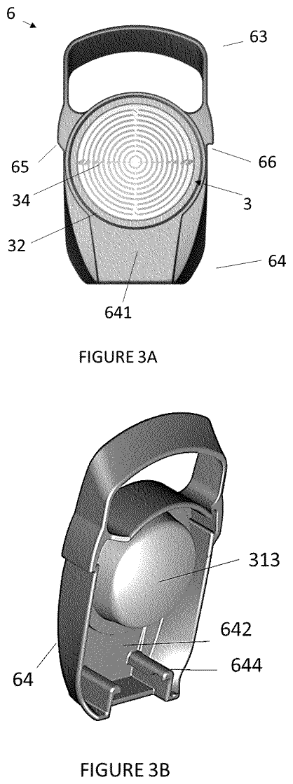

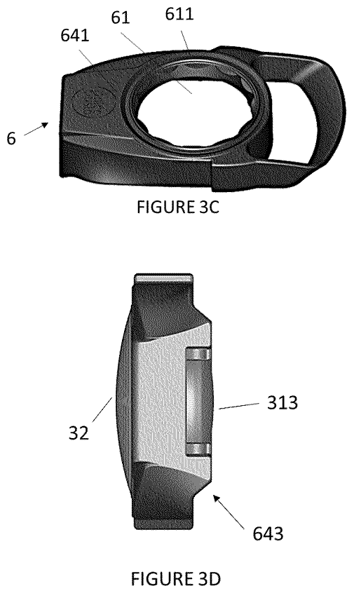

FIGS. 3A is a front view of the pod holder 6 holding a pod 3 and showing the front face 641 of the pod holder on which the lid 32 of the pod is positioned. FIGS. 3B shows the back face 642 of the pod holder on which the bottom 313 of the pod emerges. FIGS. 3C is a perspective view of the holder without any pod.

In its front face 641, the pod holder 6 presents a hole 61 configured through which the body 31 of the pod can be received. The holder and its hole are designed so that once the pod 3 is positioned in the hole 61, at least a part of the lid 32 and at least a part of the bottom 313 of the pod is not covered or enclosed by the pod holder and remains accessible for code reading and for being pierced by the downstream and upstream pod enclosing parts during the beverage preparation.

In the particular above illustrated embodiment, the code 34 is provided on the whole surface of the lid and can be read from whatever part of said lid by the code reader.

In addition, in the particular above illustrated embodiment of the extraction device, the piercing elements 12, 222 of the downstream and upstream enclosing parts are configured to pierce large surfaces of the lid 32 and of the pod bottom 313; accordingly, the holder does not comprise any shell that covers the bottom of the pod body: the bottom remains uncovered and accessible for piercing.

With other types of piercing elements of the extraction device, piercing may be provided in more limited areas of the lid and/or of the bottom and the holder may comprise some parts to enclose the pod except at that pierceable areas.

In the illustrated embodiment, the holder can comprise some retaining elements at the internal surround of the hole. These retaining elements, such as the illustrated short flexible tongues 612, can maintain the pod inside the holder by friction when the pod holder is manipulated by the user and is introduced vertically inside the insertion section.

A handle 63 facilitates the handling by the user, in particular by urging the user to orientate the pod holder with the handle positioned upwardly during the introduction of the pod holder in the insertion section, that is with the lid 32 in front of the downstream part 1 and the pod bottom 313 in form of the upstream part 2.

As illustrated in FIG. 3D, the shape of the bottom 643 of the pod holder is asymmetric. This asymmetric shape is identical to the shape of the insertion section 4 so that the user is urged to position the pod correctly between the upstream and enclosing parts as mentioned above in relation with FIG. 2D.

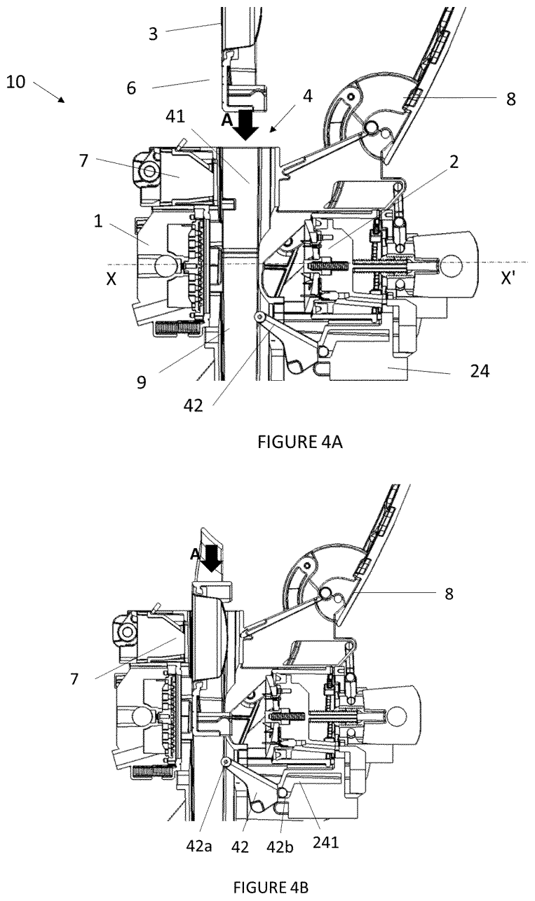

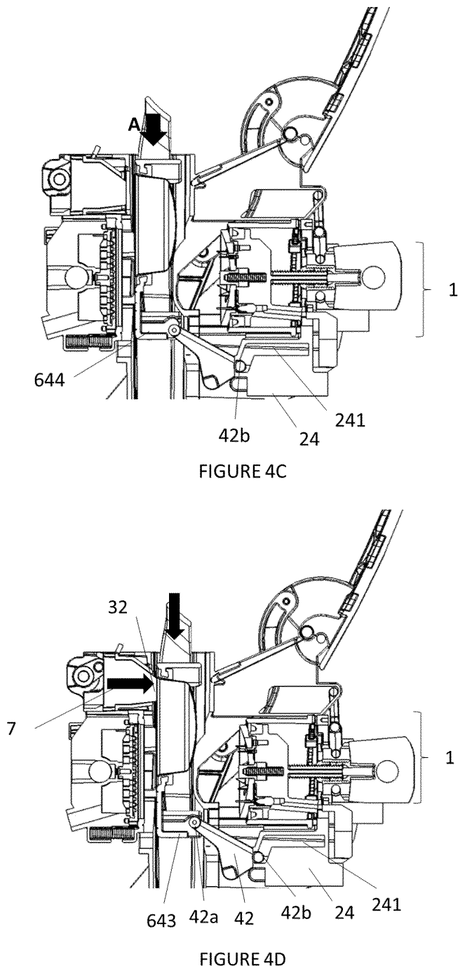

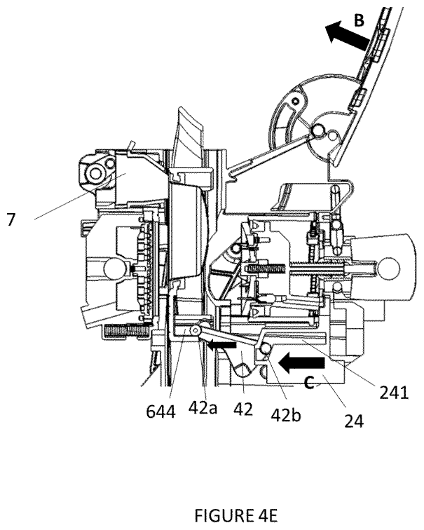

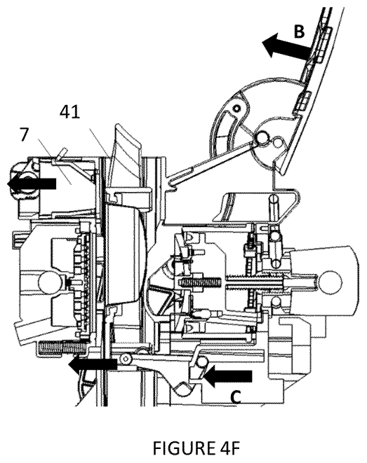

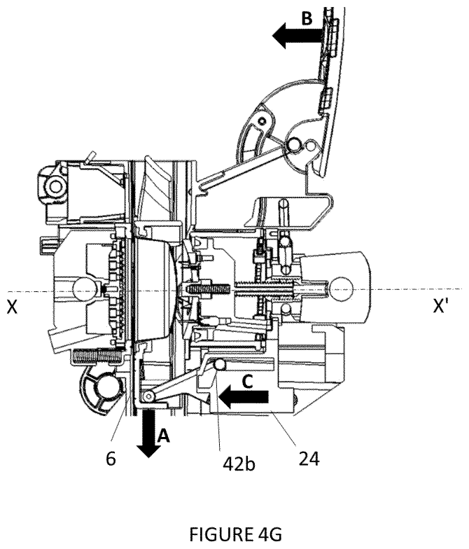

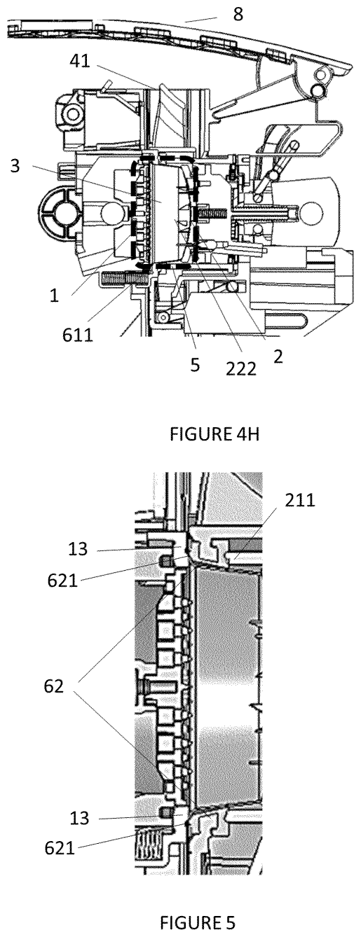

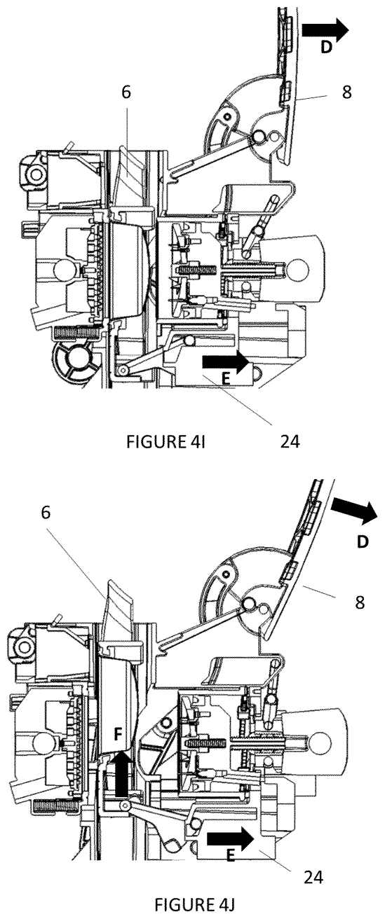

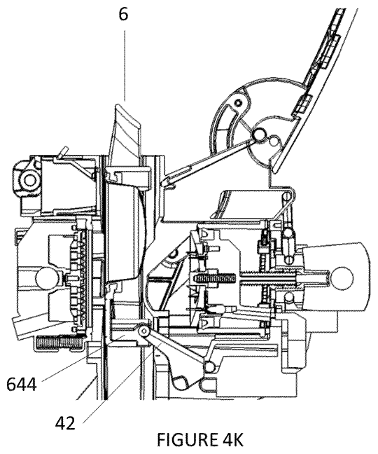

FIGS. 4A-4E illustrate the steps of introduction of the pod holder inside the extraction device 10 according to the preferred embodiment.

In FIG. 4A:
the handle 8 is in the open position where:
   it does not cover the insertion section 4, and
   it positions the two enclosing parts 1, 2 away one from the other.
the code reader 7 is positioned aside the path 41.
the pod holder 6 was loaded with a pod 3 and is positioned above the insertion section 4: it is slidden vertically inside the path 41 as illustrated by the arrow A.

In FIGS. 4B and 4C:
the pod holder 6 is being introduced in the path 41 by the user.

In FIG. 4D:
the pod holder 6 has just been stopped in an intermediate temporary position inside the path 41 by a stopper 42 on which the pod holder abuts. A downstream end 42a of this stopper 42 is configured to be positioned inside the path 41 when the handle 8 is in the open position so as to interact with the bottom 643 of the pod holder and to stop its downwards sliding movement operated by the user.

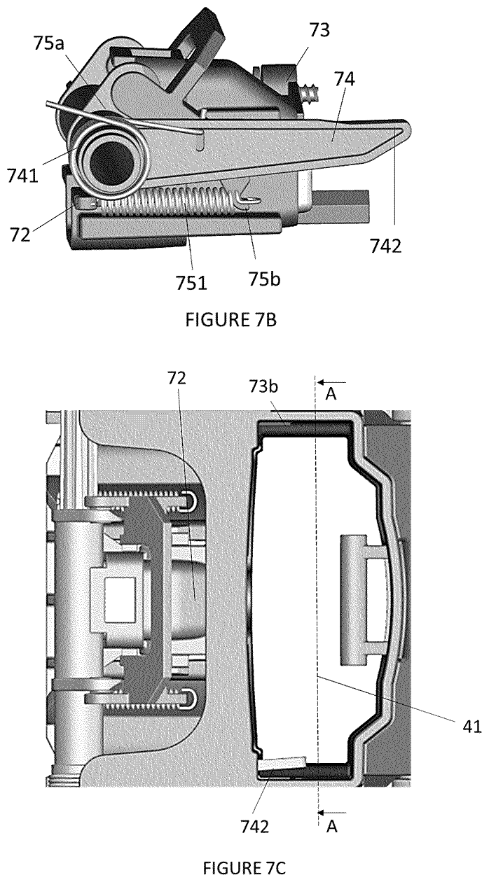

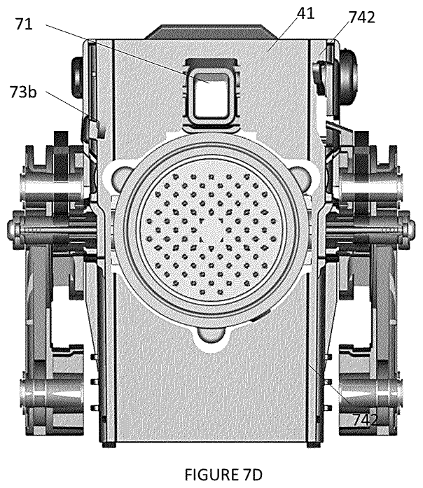

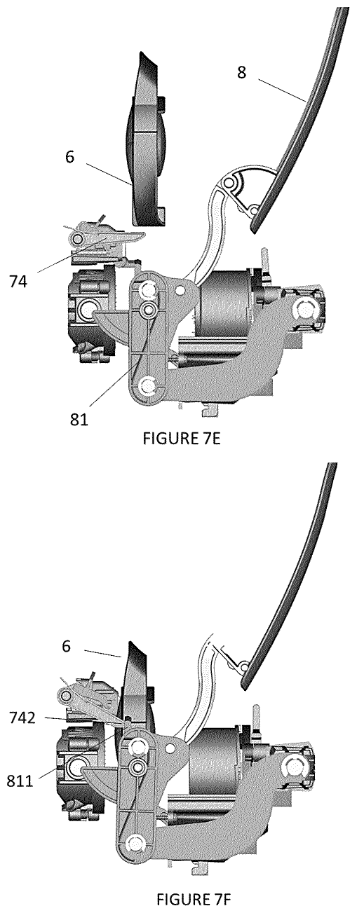

At this intermediate position, the code reader 7 is urged against the lid of the pod and can read the code as explained below in relation with FIGS. 7A-7D.

This intermediate position can enable an operation of identification or recognition of the pod by a recognition device 7 positioned in that part of the path 41 before the pod is introduced further between the enclosing parts 1, 2. This recognition device can obtain input information for the further preparation of a beverage from the recognised or identified pod.
simultaneously the downstream end 42a of the stopper becomes engaged in a slot 644 designed through the bottom 643 of the holder. This engagement is going to enable the automatic driving of the pod holder 6 to its final downwards position between the two enclosing parts 1, 2 as explained bellow.

In FIGS. 4E:
the pod holder being stopped in the intermediate position, the user can start moving the handle 8 to its closed position as illustrated by arrow B.
due to the system 81 of interrelated knee levers between the handle 8 and the carrier 24 of the upstream enclosing part 2, this upstream part starts moving in direction of the downstream part 1 as illustrated by arrow C. In this preferred illustrated embodiment, the downstream pod enclosing part 2 is moving too in direction of the upstream part.
the upstream end 42b of the holder stopper is connected to this movable carrier 24: its upstream end 42b is engaged in a slot 241 of the carrier. Accordingly, since the stopper 42 is engaged in the slot 644 of the pod holder 6, the movement of the carrier 24 induces simultaneously the movement of the stopper 42. The slots 644, 421 in the pod holder 6 and in the carrier 24 respectively are designed so that the movement of the upstream pod enclosing part 2 to the downstream pod enclosing part, that is the closure of the extraction chamber, induces the downwards movement of the pod holder between these two enclosing parts 1, 2 before these two parts form the extraction chamber.

In FIG. 4F:
the handle 8 goes on closing and the carrier 24 of the upstream part moving in direction of the downstream part 1. Due to the designs of the slots 644, 421 in the pod holder 6 and in the carrier 24 respectively, the stopper 42 goes on driving the pod holder 6 down.

During this downwards movement, the pod holder 6 is designed to move the code reader 7 back to its rest position out of the path 41.

In FIG. 4G:
the handle 8 goes on closing and the carrier 24 of the upstream enclosing part 1 goes on moving to the downstream part 1 in order to close the extraction chamber,
but the pod holder 6 stops sliding down due to the design of the slot 241 that is followed by the upstream end 42b of the stopper in the carrier. At this step of closure of the handle 8, the pod holder 6 is well aligned between the two enclosing parts 1, 2 and along the longitudinal axis XX′.

In FIG. 4H:
the handle 8 has reached its closing position and covers the path 41 of the insertion section.
the downstream and upstream enclosing parts 1, 2 and the holder 6 form an extraction chamber 5 (in dotted line) that encloses the pod 3. The bottom 313 of the pod is pierced by the piercing elements 222 and the preparation of the beverage can start by introducing liquid through the liquid outlets 223 of the upstream enclosing part.

FIG. 5 is a magnified view of the interaction of the pod holder 6 with the upstream and downstream enclosing parts 1, 2 when the extraction chamber is formed. Preferably, the pod holder comprises a seal 62 that covers all the front face and all the back face of the surround 611 of the receiving hole of the pod holder and that can cooperate with the respective surrounds of the upstream and downstream enclosing parts 1, 2 to provide tightness during the beverage preparation, in particular the edge 211 of the cage can engage with the seal at the back face of the surround of the hole and the peripheral area 13 of the downstream enclosing part can engage with the seal at the front face of the surround of the hole.

In addition, the pod holder 6 can be designed so that the annular flange 314 of the pod is pinched between the front face of the surround of the hole and the surround of the peripheral area 13 downstream enclosing part.

Preferably, the seal at the front face of the surround of the hole comprises a ridge 621 that extends along the periphery of the seal and that rises in the downstream direction.

Accordingly, in the closed position of the enclosing parts 1, 2, the flange 314 of the pod can be pressed between the seal 62 and the surround of the downstream part and can be pinched strongly by the ridge. As a result, in the flange, the paths for liquid created by the presence of potential wrinkles around the flange of the pod are closed and tightness is obtained. This embodiment is particularly useful when pods made of paper such as described above are used. In one preferred embodiment, the peripheral area 13 of the downstream part can comprise a groove 131 in which this ridge 621 can engage to increase tightness even more.

FIGS. 4I-4K illustrate the steps of removal of the pod holder from the extraction device after the extraction operation of FIG. 4H.

These steps happen while the user pulls the handle 8 to open the extraction device and movements exactly opposed to those described in FIGS. 4C to 4H happen.

In FIG. 4I, the user pulls upwardly the handle 8 as illustrated by arrow D with the effect that the carrier 24 of the upstream enclosing part 2 moves away from the pod holder 6 as illustrated by the arrow E. The two enclosing parts 1, 2 makes the pod holder 6 free.

In FIG. 4J, the user goes on pulling the handle 8 and the downstream end 42a of the stopper of the pod holder pushes the pod holder upwardly as illustrated by the arrow F.

In FIG. 4K, the stopper 42 is not engaged in the slot 644 at the bottom of the pod holder.

The pod handle can be grabbed by the use and the pod holder 6 can be pulled out of the insertion path in order to throw the extracted pod away.

During these steps, the reader does not move and remains outside the path 41.

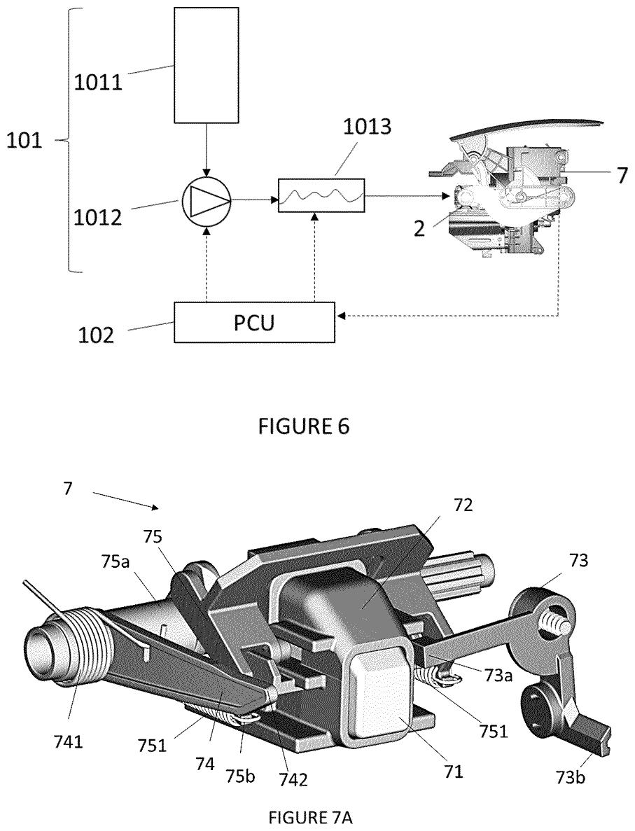

FIG. 6 illustrates the fluid system 101 of the extraction device and configured to supply the upstream enclosing part 2 with liquid. This system 101 can comprise a tank 1011 of fluid, generally water, a pump 1012 to pump that fluid form the tank and at least one device to adapt the temperature of the fluid like a heater 1013 and/or a cooler before the fluid is dispensed to the upstream part 2.

A process control unit 102 of the beverage machine is configured to control the pump and the heater once a beverage is ordered. The code reader assembly 7 of the extraction device is configured to provide the control unit with information read from the code of the pod. Based on this information, the process control unit 102 is configured to actuate the pump and the heater and/or cooler. If the beverage machine comprises a display device, specific information related to the pod can be displayed too.

The information read from the code can be used by the process control unit according to different modes:
the read code can be a reference to a type of recipe stored in the memory of the process control unit and the control unit is configured to apply that stored recipe, or
the read code can be a reference to a type of recipe stored in a remote database and the process control unit is configured to download that recipe from the remote database through a remote communication device, or
the read code can directly provide all the parameters of the recipe and the control unit is configured to apply that read recipe.

FIGS. 7A-7B illustrate the movable code reader assembly 7 of the present invention.

The assembly comprises a code reader 71. Preferably this code reader is configured to provide the best reading of the code through an operation of contact with the code. In particular, such a contact operation can be recommended if some steam or water drops are able deposit on the reader itself, for example if the code reader is positioned just above the brewing chamber as it is the case in the specific illustrated embodiment of FIGS. 4A-4K.

The code reader 7 is hold in a frame 72 and this frame is movable inside the main chassis 9 of the extraction device, in particular the frame 72 is slidable in ridges of the main chassis, said ridges enabling a back and forth movement of the frame 72 away from the path 41 of the insertion section and to this path respectively. By default, or at rest, the frame 72 is positioned outside the path 41 of the insertion section.

The movement of the frame 72 is controlled by:
a knee mechanism 75,
a retaining means 73,
a main lever 74 for actuating the knee mechanism.

The knee lever 75 is attached at its first end 75a to the main lever 74 and is attached at its second end 75b indirectly to the frame 72 by means of a spring 751 (FIG. 7B).

The retaining means 73 is attached to the main chassis 9 and is positioned to block the movement of the frame 72. The retaining means can be made movable to make the frame 72 free at one step of the operation of loading of the pod holder such as described below.

The movement of the main lever 74 actuates the knee mechanism, this main lever 74 is attached to a return spring 741 configured to move this lever back to its rest position.

The main lever 74 is positioned relatively to the path 41 of the insertion section so that its end 742 is actuated by a lever pusher 65 designed in the pod holder (FIG. 3A): in this specific embodiment, when the pod holder 6 is slidden in the path 41, its lateral lever pusher 65 pushes the lever end 742, against the force of the return spring 741 of the lever, and consequently actuates the knee lever 75. Yet, due to the presence of the retaining means 73 in front of the frame 72, this frame of the code reader is not able to move. As a result, the movement of the knee lever 75 produces a tension of the knee lever spring 751.

The retaining means 73 comprises a first end 73a that is positioned, by default, in front of a part of the frame 72 of the code reader and prevents any movement of the frame in direction of the path 41 of the insertion section. The retaining means is designed so that its second end 73b is actuated by a retainer pusher 66 designed in the pod holder (FIG. 3A) so that, when the pod holder 6 is slidden in the path 41, the retainer pusher 66 pushes the second end 72b of the retaining means which has the effect of displacing the first end 72a of said retaining means too and the effect of making the frame 72 of the code reader free to move in direction of the path 41 of the insertion section where the pod holder is present and consequently the pod is present.

The lever pusher 65 and the retainer pusher 66 are designed in the pod holder so that the lever pusher actuates the lever 74 and that lever 74 is able to tension the knee lever spring 751 before the retainer pusher 66 moves the second end 73b of the retaining means and indirectly the first end 73a of retaining means. As a result, when the retaining means 73 stops blocking the frame 72 of the code reader, this frame is urged in direction of the path 41 by the knee lever 75 that was placed under tension of its knee lever spring 751.

The pod holder 6 is designed so that when its retainer pusher 66 moves the second end 73b of the retaining means and makes the frame 72 of the code reader free to move, the lid 32 of the pod that is hold in the pod holder 6 is positioned in front of the code reader 71, and in particular the part of the lid that comprises the code faces the code reader so that the code reader is urged to the code.

In the preferred embodiment, the lid of the pod holds a code that can be read on any surface of the lid, for example a code that is repeated multiple times on the surface of the lid, so that whatever the position of the pod and the lid in the pod holder (such as illustrated in FIG. 3A), a code can be read by the code reader when it is in contact with a part of the lid.

FIG. 7C is a magnified view of the insertion section 4 of FIG. 2D (and defined in dotted lines in FIG. 2D). It makes apparent the position of the lever end 742 and the second end 73b of the retaining means in the lateral parts of the path 41 of the insertion section. FIG. 7D corresponds to the vertical section view along plane AA in FIG. 7B and shows the relative vertical positions of the lever end 742 and the second end 73b of the retaining means, the lever end 742 being pushed by the pod holder before the second end 73b of the retaining means when a pod holder such as illustrated in FIG. 3A is introduced in the insertion section.

Preferably, the pod holder 6 is designed so that the retainer pusher 66 is configured to push the retaining means 73 and to let the frame of the reader move to the pod lid 32 when the bottom of the pod holder 6 abuts and is stopped by the retaining means 42 that is when the intermediate position illustrated in FIG. 4D is reached. Accordingly, in this position of FIG. 4D, the movement of the pod holder is stopped and the code reader can read the code correctly since the pod does not move. In addition, since the second step of introduction of the pod holder in the extraction area requires the movement of pulling the handle 8 to the closure position, there is enough time for the code reader to read the code before the operator leaves the pod holder 6 to pull the handle 8 that is between FIGS. 4D and 4E.

Preferably, when the lever end 742 is pushed by the pod holder, a part of the lever 74 is configured to simultaneously activate the code reading operation by positioning a microswitch linked to the code reader. Consequently, the code reader is simultaneously positioned for an efficient reading and powered for the reading operation.

When the handle is 8 is pulled and accordingly the pod holder 6 is drawn to the extraction area by the stopper 42 as illustrated in FIG. 4E, it is preferable to retract the code reader from the insertion path 41 to avoid that the front part of the code reader is damaged, in particular scratched, by gliding along the pod lid 32.

In the illustrated embodiment, the designs of the lever end 742 and the lever pusher 65 of the pod holder are configured so that, when the pod holder 6 is in the intermediate position, the lever end 742 is hardly retained by the lever pusher 65 any longer and is retained by a lever catcher 811 attached to one of the interrelated knee levers 81. In the illustrated embodiment, the lever pusher 65 is designed to position the lever end 742 in relation with this lever catcher during the movement of introduction of the pod holder to the intermediate position.

When the handle 8 is pulled and the pod holder 6 is driven from the intermediate position to the extraction area, the lever pusher of the pod holder slides down and simultaneously the lever catcher 811 is moved by the handle and makes the lever end 742 free. Consequently, with the help of the lever spring 741, the lever 74 is urged back to its default position and folds back the knee lever 75 which moves the frame 72 of the code reader out of the path 41 and back to its original rest position as illustrated in FIG. 4F.

FIGS. 7E-7F illustrate the interaction of the lever catcher 811 with the lever 74.

The extraction device presents the advantage of enabling the reading operation through the operation of introducing the pod holder inside the intermediate position by the user. This operation does not need the use of any motor and remains invisible for the user.

Although the invention has been described with reference to the above illustrated embodiments, it will be appreciated that the invention as claimed is not limited in any way by these illustrated embodiments.

Variations and modifications may be made without departing from the scope of the invention as defined in the claims. Furthermore, where known equivalents exist to specific features, such equivalents are incorporated as if specifically referred in this specification.

As used in this specification, the words “comprises”, “comprising”, and similar words, are not to be interpreted in an exclusive or exhaustive sense. In other words, they are intended to mean “including, but not limited to”.

### LIST OF REFERENCES IN THE DRAWINGS

beverage device 10
downstream enclosing part 1
downstream plate piercing arrangement 12
spikes 121
peripheral area 13
groove 131
upstream enclosing part 2
cage 21
edge 211
upstream piercing arrangement 22
rising elements 23
liquid injector 25 p1 pod 3, 3′
body 31, 31′
side wall 311, 311′
top end 3111
top opening 312
bottom wall 313
annular flange 314
top face 3141
bottom face 3142
lid 32
annular area 321
peripheral annular area 322
beverage ingredient 33
machine-readable code 34
insertion section 4
path 41
holder stopper 42
extraction chamber 5
removable pod holder 6
pod receiving hole 61
hole surround 611
tongue 612
seal 62
ridge 621
handle 63
front face 641
back face 642
bottom 643
slot 644
lever pusher 65
retainer pusher 66
code reader assembly 7
code reader 71
frame 72
retaining means 73
first end 73a
second end 73b
lever 74
lever spring 741
lever end 742
knee lever 75
first end 75a
second end 75b
knee lever spring 751
actuator 8
interrelated knee levers 81
lever catcher 811
chassis 9

1. An extraction device for extracting a beverage ingredient by supplying an extraction liquid into a pod,
said pod comprising:
a pod body, said pod body comprising:
a side wall and a bottom wall defining a chamber, said chamber extending axially between the bottom and a top opening, and
a top lid closing the top opening of the pod body,
a machine-readable code storing preparation information, said code being arranged on the pod, and
said device comprising upstream and downstream pod enclosing parts relatively movable, along a horizontal longitudinal axis between an open position for inserting and removing the pod and a closed position for forming an extraction chamber enclosing the pod during extraction,
said device comprising a code reader,
wherein the device comprises:
a removable pod holder, said holder comprising a pod receiving hole to receive and hold the pod,
a top insertion section configured for introducing the pod holder in the device, said top insertion section comprising a path for guiding the pod holder to an extraction area between the upstream and downstream pod enclosing parts, and
a pod holder stopper to stop the pod holder in an intermediate temporary position inside said path,
wherein, in the intermediate temporary position, the pod holder is configured to hold the pod so that the code arranged on the pod faces the code reader, and
wherein the operation of reading the code by the code reader is triggered by the movement of the pod holder when the pod holder reaches the intermediate temporary position during the introduction of the pod holder in the device.

2. Extraction device according to claim 1, wherein the pod receiving hole and the top insertion section are configured to orientate the code in front of the code reader when the pod holder is in the intermediate position.

3. Extraction device according to claim 1, wherein the code reader is movable between:
a retracted position, where the code reader is positioned out of the path of the insertion section, and
a reading position, where the code reader extends inside the path of the insertion section, and
wherein the movement of the code reader from the retracted position to the reading position is triggered by the pod holder when the pod holder reaches the intermediate temporary position during the introduction of the pod holder in the device.

4. Extraction device according to claim 1, wherein the movement of the code reader is perpendicular to the movement of the pod holder.

5. Extraction device according to claim 3, wherein the movement of the code reader from the reading position back to the retracted position is triggered by the pod holder, when the pod holder moves from the intermediate temporary position to the extraction area.

6. Extraction device according to claim 3, wherein, during the movement of the pod holder inside the path of the insertion device, the frame of the code reader is successively:
spring tensioned while retained in the retracted position by a retaining member,
then moved to the reading position by removing the retaining member, and
then set back to retracted position by releasing the tension of the spring.

7. Extraction device according to claim 1, wherein:
the frame of the code reader is spring tensioned by a lever, said lever being actuated by the pod holder, and
the retaining member is moved by the pod holder.

8. Extraction device according to claim 1, wherein the extraction device comprises an actuator to move the pod holder from the intermediate position to the extraction area between the upstream and downstream pod enclosing parts.

9. Extraction device according to claim 1, wherein the actuator is cinematically linked to the holder stopper so that said stopper is configured to move the pod holder from the intermediate position to the extraction area when said actuator is operated.

10. Extraction device according to claim 6, wherein the actuator comprises a handle, and said handle closes the path of the top insertion section when the downstream and upstream parts are in the closed position.

11. Extraction device according to claim 8, wherein
the upstream part defines a cage and bears an upstream piercing arrangement for opening the bottom wall of the pod and a liquid injector,
the downstream part defines a plate transverse to the longitudinal axis, said plate comprising a downstream plane piercing arrangement for opening the lid of the pod, and
the actuator is configured to move the upstream and downstream parts between the open position and the closed position of said parts.

12. (canceled)

13. System comprising an extraction device for extracting a beverage ingredient by supplying an extraction liquid into a pod,
said pod comprising:
a pod body, said pod body comprising:
a side wall and a bottom wall defining a chamber, said chamber extending axially between the bottom and a top opening, and
a top lid closing the top opening of the pod body,
a machine-readable code storing preparation information, said code being arranged on the pod, and
said device comprising upstream and downstream pod enclosing parts relatively movable, along a horizontal longitudinal axis between an open position for inserting and removing the pod and a closed position for forming an extraction chamber enclosing the pod during extraction,
said device comprising a code reader,
wherein the device comprises:
a removable pod holder, said holder comprising a pod receiving hole to receive and hold the pod,
a top insertion section configured for introducing the pod holder in the device, said top insertion section comprising a path for guiding the pod holder to an extraction area between the upstream and downstream pod enclosing parts, and
a pod holder stopper to stop the pod holder in an intermediate temporary position inside said path,
wherein, in the intermediate temporary position, the pod holder is configured to hold the pod so that the code arranged on the pod faces the code reader, and
wherein the operation of reading the code by the code reader is triggered by the movement of the pod holder when the pod holder reaches the intermediate temporary position during the introduction of the pod holder in the device and a pod,
wherein said pod comprises:
a pod body, said pod body comprising a side wall and a bottom wall defining a chamber,
a top lid closing the top opening of the pod body,
a machine-readable code storing preparation information, said code being arranged on the pod, preferably on the lid of the pod, and
wherein the pod holder and the insertion section are designed so that the lid faces the code reader in the path of the insertion section.

14. Method to prepare a beverage with an extraction device for extracting a beverage ingredient by supplying an extraction liquid into a pod,
said pod comprising:
a pod body, said pod body comprising:
a side wall and a bottom wall defining a chamber, said chamber extending axially between the bottom and a top opening, and
a top lid closing the top opening of the pod body,
a machine-readable code storing preparation information, said code being arranged on the pod, and
said device comprising upstream and downstream pod enclosing parts relatively movable, along a horizontal longitudinal axis between an open position for inserting and removing the pod and a closed position for forming an extraction chamber enclosing the pod during extraction,
said device comprising a code reader,
wherein the device comprises:
a removable pod holder, said holder comprising a pod receiving hole to receive and hold the pod,
a top insertion section configured for introducing the pod holder in the device, said top insertion section comprising a path for guiding the pod holder to an extraction area between the upstream and downstream pod enclosing parts, and
a pod holder stopper to stop the pod holder in an intermediate temporary position inside said path,
wherein, in the intermediate temporary position, the pod holder is configured to hold the pod so that the code arranged on the pod faces the code reader, and
wherein the operation of reading the code by the code reader is triggered by the movement of the pod holder when the pod holder reaches the intermediate temporary position during the introduction of the pod holder in the device, wherein the extraction device comprises an actuating member, said method comprising the steps of:
removing the pod holder from the extraction device,
introducing a pod in the pod holder,
introducing the pod holder in the extraction device down to the temporary position, and
actuating the actuating means to move the pod holder from the intermediate position to the extraction area.

15. (canceled)
